(19) United States
(12) Patent Application Publication
(10) Pub. No.: US 2012/0188054 A1
(43) Pub. Date: Jul. 26, 2012

(54) REMOTE SECURITY ENTRANCE APPLICATION

(75) Inventor: Peter Bongard, Indio, CA (US)

(73) Assignee: EINSTEINS, LLC, Henderson, NV (US)

(21) Appl. No.: 13/011,027

(22) Filed: Jan. 21, 2011

(51) Int. Cl. G08B 29/00

(52) U.S. Cl. 340/5.61; 340/5.2

(57) ABSTRACT

A security system and method for a restricted entrance such as a vehicle gate is disclosed where requests for entry are issued from a device such as a computer or smartphone and directed to a dispatch operator. The dispatch operator locates the position of the requested entrance and sends a request to a control computer that verifies the user's authority to enter. If the user is authorized for entry, the control computer sends a command to a gate opening device or other mechanical device to open or unlock the gate. The system can also be used with software running in background to automatically send a request for entry when the user is within a predefined distance from the gate using GPS technology or other means.

### BACKGROUND

Gated communities have become more popular in recent years, as homeowners seek the security of regulated access to their neighborhoods. The “gates” come in many forms, from manned stations to automatic gates that are opened by remote control. Residents are permitted to enter through the gates, while visitors must either register or be allowed in by someone within the gated community. In this way, intruders are deterred from entering the community.

While the security of a gated community offers protection to its residents, it presents some problems to delivery people, as well as municipal workers, emergency workers, police, and the like. By excluding these entities from the neighborhood, these gated communities make it more challenging for these types of workers to perform their duties. In the case of police, more often than not patrol cars will drive past a gated community simply because of the time and effort involved to gain access. For example, in some gate communities there is a “Knox Lock,” i.e. a key switch to open a locked gate for which only law enforcement and EMS personnel have a key. It is typically mounted in the vicinity of the entry gate, but there is no universal location for obvious reasons. Thus, to access the gated community a police officer must stop his vehicle, put it into Park, remove his seat belt, exit the vehicle, locate the Key switch, insert the key and turn it to open the gate and then turn it back and remove the key, get back into the vehicle, re-attach his seat belt, put the vehicle in drive and enter the gate. In the event of an “Emergency Entry,” the first worker on scene will perform the same functions except the worker may leave the key switch turned “On,” holding the entry gate open if time is of the essence or other emergency vehicles are also in route. In many instances, the person who locked the gate in the open position doesn't have the time to go back and close the gate or simply forgets. Which ultimately requires a trip by another Law Enforcement or EMS vehicle, requiring and wasting additional manpower and vehicle costs. Additionally in most gate locations the “Knox Lock” only locks open the Entry Gate(s). If other gates need to be opened, as is the case in many gated communities, then this situation has to be repeated again as many times as necessary.

### SUMMARY OF THE INVENTION

The present invention is a system and method for gaining access to a gated or controlled entrance using a secure communication that works with local police agencies to protect entrance through a gate, door, parking garages, parking lots, home garage doors and the like. The present invention's initial focus may be concentrated around police, law enforcement, and emergency vehicle access through vehicular gates, although as explained below the system can be used for other purposes as well. It utilizes software, a web based server (hereafter sometimes referred to as a “Control”) and a gate located access device that interfaces with the gate opening equipment.

The present invention meets the needs of a multitude of scenarios for gate access. In one embodiment it comprises a web-based software client, that is installed and operational at a local law enforcement dispatch center. When a police or emergency vehicle approaches a security gate, the police or emergency vehicle contacts the dispatch via radio or other mode of communication and informs the dispatch clerk of their location, typically Street name with a cross street. Utilizing a simple software search function, the dispatch clerk confirms the gate location and, while running the software, uses a computer mouse to click on an icon that says “Open Gate.” The mouse click causes the program to issue a command that is cleared through the server “Control,” and the request is forwarded to the gate located access device at the gate. The gate located access device can communicate across the internet and control the gate's opening mechanism to cause the gate to open and then close the gate, or hold the gate open for a predetermined time period before closing the gate, giving the Police, Law Enforcement and Emergency Services personnel adequate time to complete their response call.

As an alternative embodiment, the present invention may reside as an application (or “app”) on a smartphone such as a Google Android™ or iPhone™ When activated, this app collects and tracks the phone's global positioning satellite (“GPS”) coordinates. If a user approaches a gate location where they require access, the app can be activated by simply pressing a key or icon on the phone. The phone will send a message to the control computer, requesting gate access. The phone sends the GPS information, along with an identifier that uniquely identifies the user. The computer verifies that the phone is within a predetermined radius of the gate, the user is approved for entry of the particular location (gate), for the given time of week and time of day. Once authorized, the control computer sends a command to the gate located access device at the gate to actuate the necessary mechanisms to open (or unlock) the gate. Police, Law Enforcement and EMS personnel and perhaps others will have an additional option on their phone for “Emergency Entry,” thereby holding the gate open for a predetermined period of time.

In yet another embodiment, the present invention may comprise software in the form of a program or application on a smartphone such as a Google Android™ or iPhone™, running as a service in the background. In this case, the operation is invisible to the user and is “hands free” in that it will require no user intervention to activate. The program running on the smartphone, or app, collects and continuously tracks the phone's GPS coordinates. Whenever it is within a predetermined distance of a gate for which the phone is approved for entry, it will automatically send a request to the control computer requesting gate access. If the phone is valid for that location (gate), time of week and time of day then the control computer sends an “Open Gate” command to the gate located access device to actuate the machinery that opens the gate. Again Police, Law Enforcement and EMS personnel and perhaps others will have the option to press an additional button on their phone which is for “Emergency Entry,” thereby holding the gate open for a predetermined period of time.

In addition to the software running on a police or EMS dispatch computer, software can also be installed and run on a police, law enforcement, EMS, or private security response vehicle mounted laptop computer. Utilizing GPS signals, it can automatically validate the vehicle's location and send an “Open gate” request to the control, which would validate and send a command to the gate located access device to open the gate. As with the previous example, the user has complete control over a simple “Open Gate” command or an “Emergency Entry” command, thereby holding the gate open for a predetermined period of time.

The present invention has the benefit of eliminating or reducing the time currently spent waiting for the gate to open and the time needed to open the gate. In emergency situations, this can be critical. The amount of time it takes to safely stop the vehicle, get out, locate the existing Knox Lock, insert a key and lock the gate open, get back into the vehicle, and safely drive through the gate could be the difference between life or death. It also could be the difference between catching an intruder or just barely missing them.

### BRIEF DESCRIPTION OF THE DRAWINGS

FIG. 1A is a schematic diagram of an illustration of the present invention;

FIG. 1B is a schematic diagram of an illustration of a second embodiment of the present invention;

FIG. 2 is a control diagram of flow chart of the embodiment of the present invention illustrated in FIG. 1A;

FIG. 3 is a control diagram of flow chart of the embodiment of the present invention illustrated in FIG. 1B;

FIG. 4 is a control diagram of flow chart of another embodiment of the present invention.

### DETAILED DESCRIPTION OF THE PREFERRED EMBODIMENTS

The present invention is a system, method, and apparatus for providing pre-approved access to a secure entrance, be it a parking garage, a gated community, a secure business, or the like. There are multiple embodiments that fall within the scope of the invention, and several examples will be described below. At the center of the invention is propriety software and a communication link connecting a control computer and devices for opening a secured entrance. The communications link is preferably a form of electronic data transmission across, for example, an internet connection. The connection may be wireless or hardwired, but in most cases for vehicle authorization the connection will be across some wireless network such a wireless telephone network or wifi network. Further, it is anticipated that access to the internet will be preferred, although the system can operate outside of the internet as well.

A first embodiment will now be described with reference to the figures. In this embodiment, there are several steps to install and set up the system for operation. First, a client interesting in using the system of the present invention uses a device such as a computer, smartphone, PDA, or other device with a processor to access the internet. Then, the user downloads or otherwise acquires the necessary software to load on the computer which will be used to open the secured entrance. In a preferred embodiment, this device will also have GPS capability. The client will also download software that will direct a device, such as a motor-operated gate opening device or a door lock, to open via a gate located access device. The software and hardware are installed on the respective devices, and the remote devices are configured for communication across a secured or unsecured network.

### EXAMPLE 1

The first step before a client can access the system of the present invention requires that each gate or security entrance location be documented and it's location and description entered as data into the memory storage of the system. The gate activation device, door lock, or other security measure at the entrance is installed with a proprietary program or software that allows the gate, door, or the like to be unlocked and or opened via an internet connection or other remote method. The user must also register and include information that allows the system to authenticate and validate the user's request for entry to the secured entrance. The system controls a multitude of gate locations, and additional gate locations are added as each location is installed, tested and brought online. As each gate is brought online, the users with valid access to them, will be software configured. Of course, some users will have access to multiple gates and some users may only have authorization for a single gate.

The access control software is preferably accessible from any internet ready Windows or Mac computer or smart phone, over a secure connection, by a pre-authorized validated user. Using any secure web browser, the user goes to the URL assigned to the system, where the user may be asked to confirm his/her credentials. This can be conducted using a username and password system, or other type of authentication. Once entered the user is validated and based on the user's access privilege level, the software will cause the device's display to show gate location(s) that are valid and listed as accessible to the user.

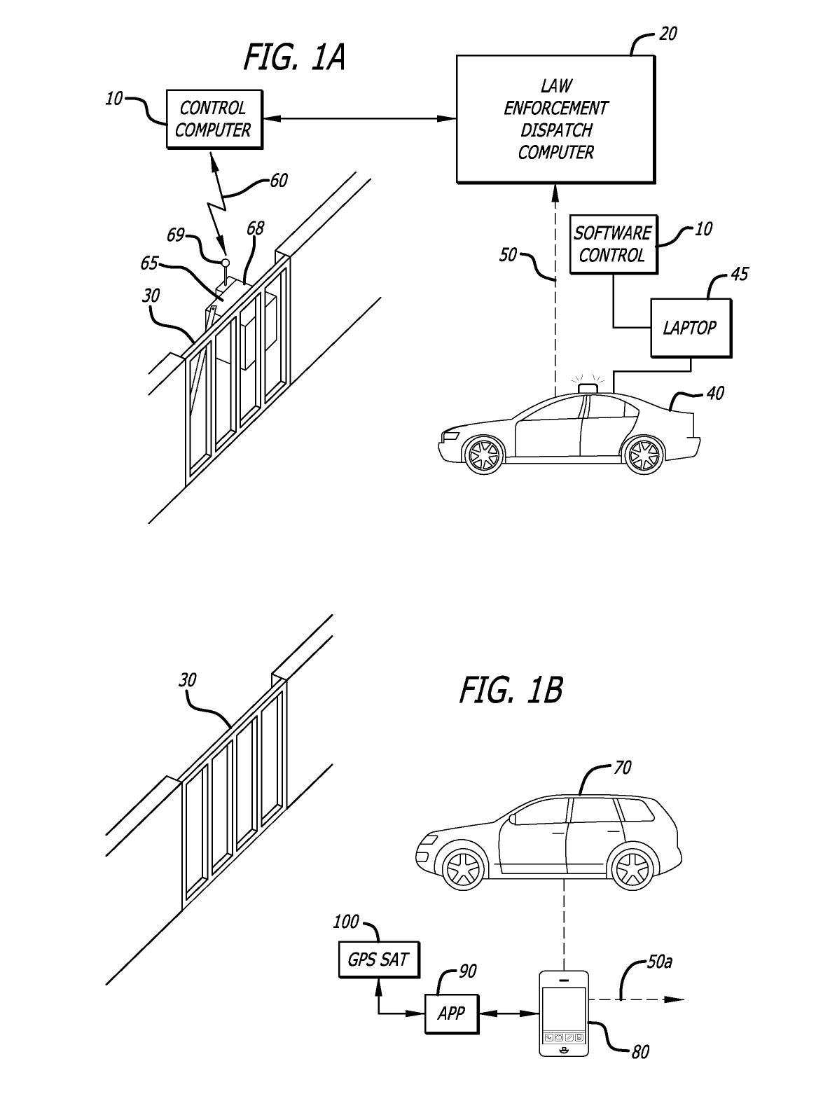

As shown in FIG. 1A, when a police or EMS vehicle 40 responder is in route or already at the gate 30, they will contact an EMS/Police dispatch computer 20 via radio, cell phone or any other means that forms a link 50 and inform them as to the location they are heading to or currently at. In some situations, the dispatch operator may already know where the emergency vehicle or EMS are going and will be able to open the gate(s) prior to their arrival. Knowing the destination gate location is important and as previously noted each will be established and validated.

In the above situation, when access is required for a particular gate, the dispatcher operator or user uses the computer 20 to conduct a search for the gate location based on one of several criteria. Criteria can be a community name (in the case of only one gate location for the community), street name, street name with nearest cross street, gate alpha designation, or GPS coordinates. A gate designation may be a 4 digit alpha designation, pre-assigned and articulated within the software. Each client community may have a large reflective sign that designates it is a client of the present invention and includes a 4 digit designation. Using a 4 digit system will add simplicity as all dispatch, police and EMS responders already know the Alpha Code system. Designations such as ACPZ would be ADAM-CHARLIE-PAUL-ZEBRA.

Once the dispatch operator locates the correct gate 30, a display on the computer 20 will allow the operator to use a pointer such as a mouse to “click” on an icon on the screen. The icons can represent several possible options, including:

OPEN GATE, opens the security gate using the same equipment on the gate that is used to open the gate for other methods.

CLOSE GATE, closes the gate. This option would be used most often when the police or emergency vehicle has exited the community and it is no longer necessary to hold the gate open. Using this option also eliminates the need to have a patrol car or other vehicle go to the community where a Knox Lock was previously used and the police or EMS services user was unable to or forgot to close the gate.

RESET GATE, power cycles the gate's electronics. This options is useful when there has been an equipment malfunction or power outage. Most often equipment problems can be solved by initiating a power reset. By performing this remotely the community can save hundreds if not thousands of dollars each year in service truck rolls and labor fees.

EMERGENCY, opens the Entry and Exit gates, if so configured, and holds them open for a predetermined, configurable amount of time, typically 30 minutes. When EMERGENCY is activated, a flashing red light may be installed that can be seen locally at the gate, signifying an Emergency situation has occurred and access has been granted through all gates. Using EMERGENCY allows the gates to be open before the police or EMS arrive, eliminating the wasting of precious response seconds.

When the dispatch operator has entered the command using the pointing device, the request is sent to a control server or computer 10 that is the heart of the invention. The control computer 10 evaluates the request, including any limitations or pre-conditions for entry. If the request is valid and the conditions are met, the control computer 10 sends a signal 60 to the gate located access device 65 using an internet connection, a wifi connection, or other type of communication link, to cause the gate located access device to open the gate. At the same time, a signal is sent back to the dispatch computer 20 that the request has been sent. A popup on the display screen informs the user that the command was successfully executed and the gate has Opened, has been Closed, has been power Reset or in the case of EMERGENCY is currently held open. Successfully executed means that the request is sent from the dispatch computer 20 to the control computer 10, which validates the request and then subsequently sends a command 60 via the internet to the gate located access device 65.

As stated above, the location for each gate 30 must be validated by determining and documenting the gate's location. Gate credentials could include the gate's description, typically the community's name, the street and street address if available, the nearest cross street and GPS coordinates. Once complete, the location and all of the associated credentials are entered into the system's software.

Each gate can be implemented with a gate located access device 65 that provides all of the necessary gate control. The OPEN, CLOSE, RESET and EMERGENCY commands are all carried out locally by the remote access device. In a preferred embodiment, the gate located access device is a internet ready device. It preferably has a fixed IP address and a single port forward on the local network. In a preferred embodiment, the gate located access device includes a monitoring circuit that monitors itself and the network and, in the event of a glitch or failure, automatically resets itself and the network. In the background, the gate located access device 65 checks the control computer 10 and provides status updates letting the control computer 10 and the users know each gate's status.

The gate located access device 65 may be installed within a secure, environmentally safe housing 68 adjacent the gate 30. For example, the device may be housed inside a steel or fiberglass enclosure, with an antenna 69 for receiving wireless signals. Power and an internet connection (not shown) are also preferably installed into the enclosure 68. The gate located access device 65 may be configured for a local network with a static IP address and one port forwarded through the network router. Low voltage control wiring can be installed between the device and the opening mechanism.

Each community and gate location may have a large aesthetically pleasing reflective sign that displays the 4 digit Alpha designation of the gate. It will preferably be installed in the same location at each gate, and therefore police and EMS can easily recognize it and call in the Alpha designator.

Returning to FIG. 1a, the police 40 sends a signal to the dispatch computer 20, which connects to a linked control computer 10 to authenticate and validate the request made by the police using a laptop 45 running the gate request software on the control computer. Once authenticated, the control computer 10 sends a signal 60 to the gate located access device 65 associated with the gate 30 that can open, close, or hold the gate open or reset the gate's electronics remotely, depending on the command sent from the dispatch computer 20.

FIG. 1B shows a slightly different version of the invention for individual use. In this embodiment, a user who may be a resident of the community, an employee of a company with a secure entrance, or some other non community service (police, EMS) personnel seeking entry into the gate 30. In this embodiment, the user uses a smartphone 80 such as an iPhone™, a Droid™, a Blackberry™, or any number of such devices on the market. The driver of the car 70 will have the smartphone 80, which includes software in the form of an application that performs the steps of the present invention. The smartphone 80 will also preferably have GPS capability 100, where the GPS data is accessed by the application 90 and used to locate the vehicle 70.

Prior to the software 90 being loaded on the smartphone 80, the prospective user must request access credentials from the control computer 10. Assuming approval, the application is sent to the user's phone and can subsequently be installed on the smartphone. Once loaded, it is authenticated for the user by validation control computer 10 by signal 50a. The user may be sent an encrypted access code that is associated with the particular, authenticated smartphone 80 and the application 90. When the user/phone 80 approaches a gate 30 where the user has access privileges, the user may call up the application 90 on the smartphone 80. The user will see a prompt or an icon on the smartphone's display screen that says “OPEN GATE?” regardless of the user's location. However, the application 90 will not validate the request until the phone is within a prescribed distance (e.g., 35 feet or less) of the gate 30. If the command is sent to open the gate by pressing the OPEN GATE icon on the phone's display, the smartphone 80 using the application 90 sends a signal 50a directly to the control computer 10. The remaining operation progresses similar to the situation described with respect to FIG. 1A, where the control computer 10 verifies the user, confirms all conditions and exclusions are evaluated, and executes the requested command to open the gate 30 by sending a signal 60 from the control computer 10 to the gate located access device 65. Assuming the user has privileges and the GPS coordinates indicate the phone is within range of the gate, the control computer 10 will execute the command and the phone's display will indicate that the “GATE OPEN” command was successful. Once the gate is open, the user can close the application 90.

In yet another embodiment, the user simply starts the application 90 so that it runs in the background of the phone's operating system. While the user drives, the application 90 constantly tracks the phone's location using the GPS data from the GPS receiver 100 and, whenever the user approaches the gate 30 as determined by the application 90, the application will send a command via a signal 50a to the control computer 10 to open the gate using the gate located access device 65. No interaction from the user is required, as the process all takes place in the background of the phone's operating system and in the phone's application 90.

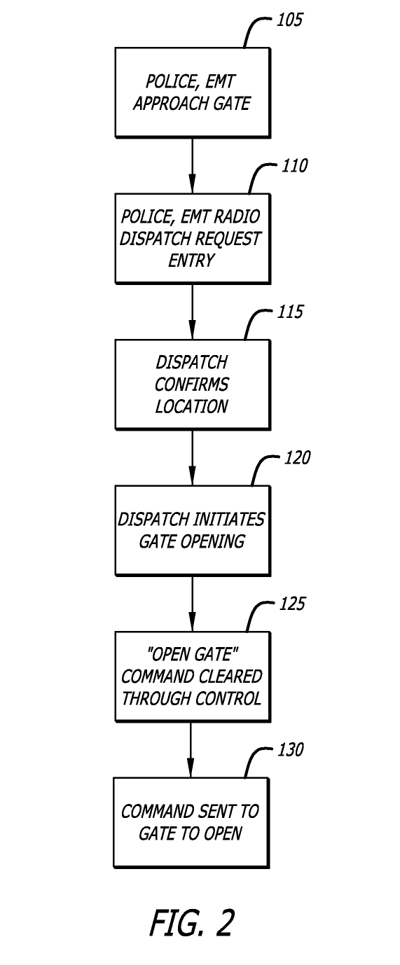

FIG. 2 illustrates a flow chart of the process depicted in FIG. 1A. In step 105, the police or emergency vehicle 40 approaches a security gate 30. Note that throughout this application, when “security gate” is referenced, it is understood that this can refer to any gate or door that is secured, such as a garage door, parking garage entrance, security door, or the like, and that no limitation should be inferred from the term “security gate” throughout this disclosure. Once the police car 40 approaches the gate 30, the user issues a request in step 110 to open the gate 30 and the dispatch operator confirms the gate's location in step 115. The dispatch operator via computer 20 sends a request to the control computer 10 to open the gate in step 120, which is verified and authenticated in step 125 by control computer 10 running the software of the invention. Once confirmed, the command is send via signal 60 by the control computer 10 to the gate located access device 65 in step 130 that, in turn, opens the gate 30 allowing the police car 40 to pass through.

The situation is similar when an emergency situation occurs. When an emergency call comes in requiring access to a security gate or other secure entrance, the police or emergency dispatch takes the 911 call and subsequently initiates a look-up of the gate or entrance in the dispatch's search software. Once the gate location has been confirmed, the dispatch initiates an Emergency Open request that is sent to the control computer 10. The control computer evaluates and confirms the request, then sends a signal 60 to the gate located access device 65 to open the designated secured entrance 30. A message may be sent back to the dispatch that the request is approved and the action taken. In this scenario, when the police or EMS services arrive at the gate, the gate 30 is already open and available for unencumbered entry.

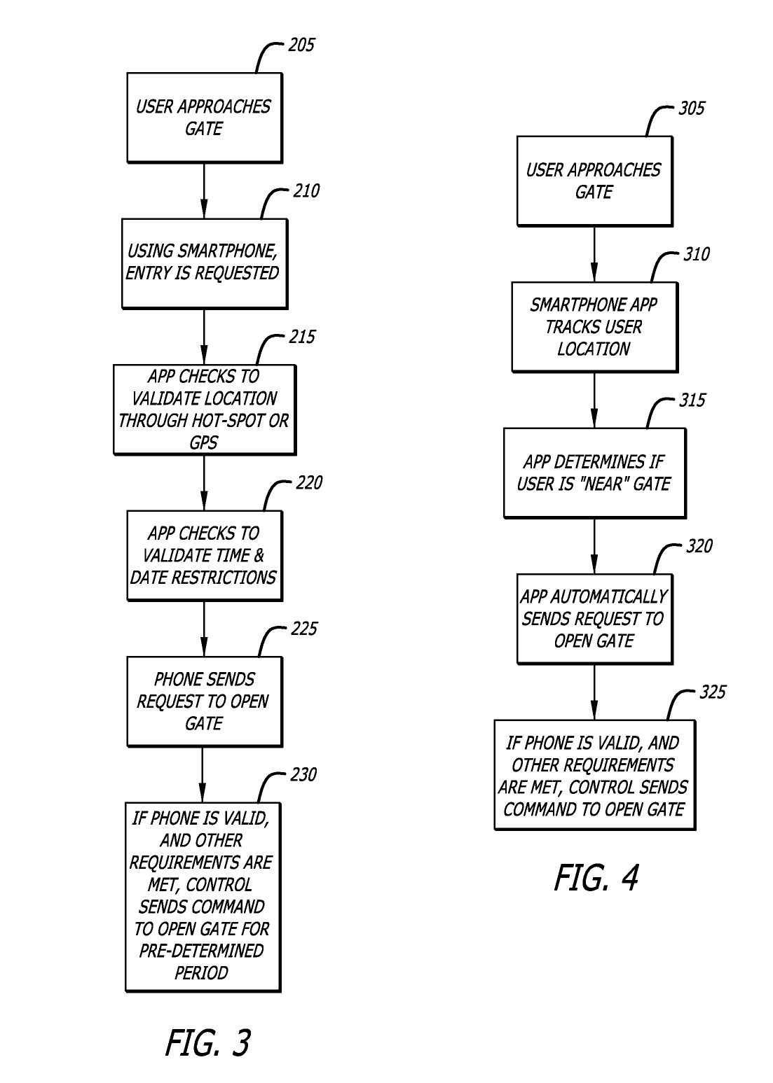

In FIG. 3, a flow chart illustrates the steps of the embodiment of FIG. 1B. In step 205, a user approaches the gate 30. The user takes out a smartphone 80 in step 210 and requests entry to the gate 30. The smartphone 80, using the loaded application 90, captures the GPS coordinates and sends the information in step 215 to the control computer 10 via signal 50a. After confirming that the vehicle 70 is located in proximity with the gate 30, the control computer 10 validates any other restrictions such as time, date in step 220. Once all restrictions are checked, the control computer 10 sends a signal to the gate located access device 65 step 225. If all conditions and restrictions are satisfied, the gate located access device 65 opens gate 30 in step 230.

In FIG. 4, another embodiment is illustrated where the application on the smartphone operates in the background without user intervention. In this case, as with the previous case the user approaches the gate in vehicle 70 in step 305. The smartphone application 90 runs continuously on smartphone 80, and in step 310 tracks the user's location with either a GPS signal or a hot spot reception. Once the application 90 detects that the vehicle 70 is within range of the gate 30, the application 90 automatically sends a signal 50a to the control computer 10 requesting that the gate 30 be opened, along with information on the smartphone 80 in step 320. The control computer 10 confirms the identity of the smartphone 80 and evaluates any restrictions or conditions, and if all conditions are met the operator sends a command 60 to open the gate 30 in step 325.

The present invention has many practical uses, such as by city/county employees who require access to gated residential areas. City inspectors, dog catchers, and municipal utilities such as electricity, water and gas can now gain access much more quickly and easily, saving the community time, manpower and money. The present invention can also reduce wait times for delivery personnel such as UPS, FED EX and the like who often have to wait at a gate until an authorized person can let them in. Instead, with the system in place a delivery truck, or using software located at the company's dispatch center, can open a security gate on arrival using a smartphone and the right application. This would greatly increase efficiency of these carriers and lower overall costs as well. The present invention also eliminates the need for a security company alarm response patrol to stop at a gate and enter a code, or worse stop at a call box and contact a resident for access.

The present invention also reduces the need to distribute gate code's to vendors and other personnel, where the codes can end up in the wrong hands. Vendors and Contractors who are authorized will be able to access the security gates based on day of week and time of day. The present invention also allows the software to track vendors and contractors entry access to see who is entering the security gate, how often, and at what times. The system can be changed quickly to deny access to someone who has been relieved of their job or for some reason access is no longer desirable. This cannot easily be done with a code that all residents have, since continuously changing the codes is not practical.

The present invention also eliminates the need for gate remotes that can be lost or broken, transponders, bar codes, and all other less satisfactory access control devices. Many residents who keep their remotes or transponders in their car forget to switch it when they are in a different car, causing aggravation. Since most people carry their smartphone around wherever they go, they always have access to their security gate. The present invention is also responsive, easy to use (no codes to memorize) and completely secure.

The foregoing description is intended to be illustrative and not limiting. There are many variations and modifications that would be known to one of ordinary skill in the art, and those variations and modifications are intended to be included within the scope of the invention. The figures are also intended to be exemplary only, and not in any way limiting. Thus, the measure of the scope of the present invention is properly judged by the words of the appended claims, where said words are given their ordinary meaning consistent with (but not limited by) the preceding discussion and descriptions.

I claim:

1. A system for granting access to a secured entrance comprising:
a first device for contacting a remote dispatch for requesting permission to enter the secured entrance;
a dispatch computer at the remote dispatch for determining a location of the secured entrance, and sending a request to a control computer for permitting access through the secured entrance;
a control computer with software that evaluates a request for entry from said dispatch computer, and further comprising a communication link between the control computer and the secured entrance that controls entry through the secured entrance; and
an entrance located access device adjacent the secured entrance for receiving a command from the control computer via the communication link, and providing access through the secured entrance in response to the command.

2. The system of claim 1 wherein the communication link between the control computer and the secured entrance uses the Internet.

3. The system of claim 1 wherein the first device is a laptop computer mounted in a vehicle.

4. The system of claim 1 wherein the first device is a smartphone running an application for communicating with the remote dispatch.

5. The system of claim 1 wherein the secured entrance is a gate to prevent unauthorized vehicles from passing.

6. The system of claim 1 wherein the first device provides GPS location data of the first device's position.

7. The system of claim 1 where entrance through the secured entrance is dependent upon time of day restrictions.

8. A method for accessing a secured entrance comprising:
approaching the secured entrance;
sending a request for entry through the secured entrance using a first device, where the request is directed to a remote dispatch;
receiving said request by the remote dispatch, and identifying the secured entrance;
validating the request for entry using a control computer running software for evaluating such requests, and providing a result of the validating;
issuing a command from the control computer to the secured entrance to allow access.

9. The method of claim 8, where the first device is a laptop mounted in a vehicle.

10. The method of claim 8, where the first device is a smartphone.

11. The method of claim 8, where the first device uses GPS data to determine a proximity of the first device to the secured entrance.

12. The method of claim 8, wherein the first device automatically sends the request for entry when a distance between the first device and the secured entrance is less than a predetermined distance.

13. The method of claim 8, wherein the first device sends a validation code to the dispatch to identify the first device for a purpose of authorizing entry through the secured entrance.

14. The method of claim 8 where the secured entrance is a vehicle gate.

15. The method of claim 8 wherein the connection between the secured entrance and the dispatch is across the Internet.

16. A system for granting access to a secured entrance comprising:
a first device for contacting a control computer for requesting permission to enter the secured entrance;
a control computer with software that evaluates a request for entry from said first device, and further comprising a communication link between the control computer and the secured entrance that controls entry through the secured entrance; and
an entrance located access device adjacent the secured entrance for receiving a command from the control computer via the communication link, and providing access through the secured entrance in response to the command.

17. The system of claim 16 wherein the communication link between the control computer and the secured entrance uses the Internet.

18. The system of claim 16 wherein the first device is a laptop computer mounted in a vehicle.

19. The system of claim 16 wherein the first device is a smartphone running an application for communicating with the control computer.

20. The system of claim 16 wherein the secured entrance is a gate to prevent unauthorized vehicles from passing.

21. The system of claim 16 wherein the first device provides GPS location data of the first device's position.

22. The system of claim 16 where entrance through the secured entrance is dependent upon time of day restrictions.
